(19) United States
(12) Patent Application Publication
(10) Pub. No.: US 2024/0330804 A1
(43) Pub. Date: Oct. 3, 2024

(54) SYSTEM AND METHOD FOR ORGANIZING, PROCESSING, AND ACCESSING A DATABASE

(71) Applicants: Sam Prudhomme, Fremont, CA (US); Jack Vonich, Fremont, CA (US)

(72) Inventors: Sam Prudhomme, Fremont, CA (US); Jack Vonich, Fremont, CA (US)

(21) Appl. No.: 18/190,918

(22) Filed: Mar. 27, 2023

(51) Int. Cl. G06Q 10/0631

(52) U.S. Cl. CPC G06Q 10/06313

(57) ABSTRACT

A system and method for organizing, processing, and accessing a database, comprising the steps providing a database; storing, on said database, a plurality of data from a plurality of previous projects; wherein said previous projects comprise a total previous project metric; wherein said data total previous project metric comprises one or more task classes; wherein data from this database is utilized to predict future project metrics.

### FIELD OF USE

The present disclosure is related to systems and methods for monitoring conversations and contemporaneously providing helpful information and feedback on a continuous basis.

### BACKGROUND

Many companies have accumulated, with the intention of analyzing, vast amounts of data relating to day-to-day operations in an attempt to improve future performance. Analyzing old data may be especially difficult because a plurality of factors may have impacted past performance in ways that are difficult to predict, but through which a human with significant amounts of experience may apply their intuition to make predictions regarding workflow solutions.

Critically, human intuition can only be used by the human possessing the intuition. Accordingly, as humans possessing the experience or intuition to determine likely outcomes and requirements may at time be fleeting, especially as human employees change their employment over time.

As data technologies continue to develop, one focus is applying the data to predictive future events, such that work performed previously under different circumstances may be applied moving forward.

Accordingly, what is needed is a system and method for applying collective experience to improve future outcomes while accounting for regularly changing employees.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to a system that creates a system configured to analyze data from previous projects comprising a plurality of types of tasks. Each task may be assigned a weighted value, determined based on a base value and secondary values. The base value may be constant, based on the type of task, whereas the secondary values may be determined based on the number of occurrences of one or more sub-tasks. In some embodiments, multiple sub-tasks may be grouped together to comprise a task. In some embodiments, the sub-tasks may be referred to as variables of the task. Each of the sub-tasks may comprise a weight multiplier, such that the number of occurrences of a sub-task multiplied by the weight multiplier may be one way to determine secondary values.

One embodiment may be a method for organizing, processing, and accessing a database, comprising the steps: providing a database; storing, on the database, a plurality of data from a plurality of previous projects; wherein the previous projects may comprise a total previous project metric; wherein the total previous project metric may comprise one or more task classes; wherein the task classes may comprise one or more sub-task classes; determining a base reference value of each of the one or more task classes based on the total previous project metric; determining a secondary reference value of each of the one or more sub-task classes based on the total previous project metric; providing one or more present projects; identifying one or more present tasks of the one or more present projects; identifying one or more present sub-tasks of the one or more present tasks; correlating the one or more present tasks with the one or more task classes and applying to the one or more present tasks the base reference value of the one or more task classes to generate a base present value; correlating the one or more present sub-tasks with the one or more sub-task classes and applying to the one or more present sub-tasks the secondary reference value of the one or more sub-task classes; multiplying the secondary reference value by a number of instances of the present sub-tasks to generate a secondary present value; adding the base present value and the secondary present value together to generate a weighted present value; converting the weighted present value into a currency or time; comparing the weighted present value to an actual value of the present project upon completion of the present project; revising the base reference value and/or the secondary reference value to account for differences between the weighted present value and the actual value; wherein the one or more task classes may comprise a total of n task classes, each having an nth weighted present value; and calculating a total present project value by adding together a sum of the n task classes. It is understood that one or more of these steps may be omitted.

In some embodiments, the present disclosure may allow for the aggregation of past data in order to calculate likely outcomes of a future scenario. In early embodiments this past data may be somewhat subjectively generated based on an individual's personal experiences, but in preferred embodiments the past data may be generated based on the present system, or be modified as the result of information and data gathered by the present system. In some embodiments, the present system may be considered to disclose a machine learning based system.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIGS. 1A-B are a flow diagram of one embodiment of a method for organizing, processing, and accessing a database.

FIGS. 2A-B are set of tables that represent various values and calculations for a project.

FIG. 3 is a table showing a set of variables considered for a particular task.

FIG. 4 is a flow diagram showing how various data may be processed and used for a project.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

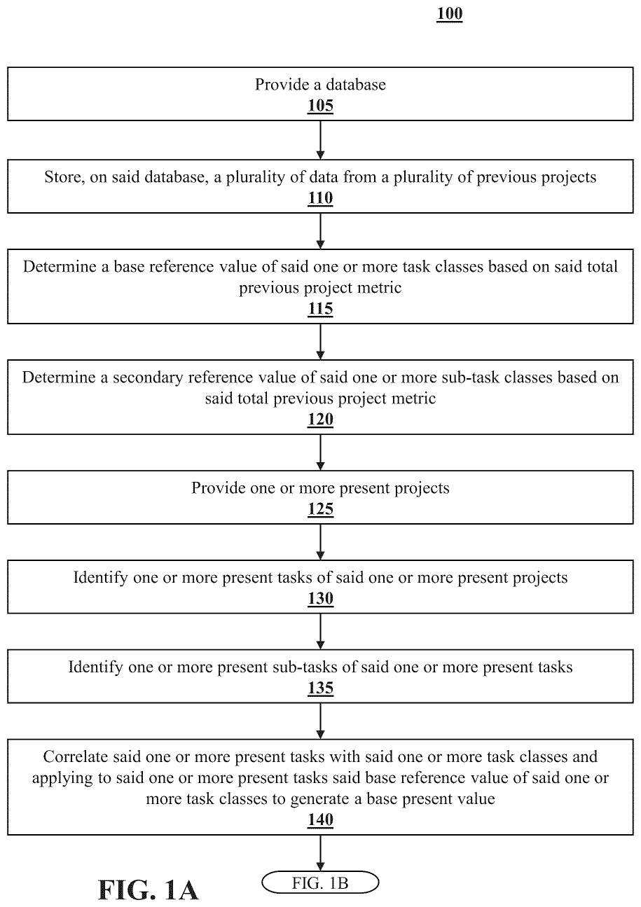

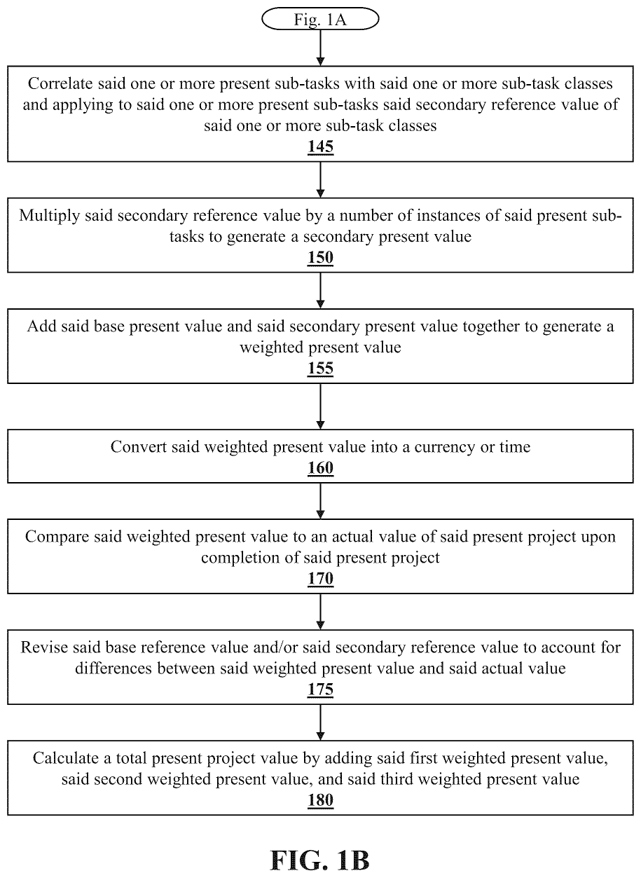

FIGS. 1A-B are a flow diagram of one embodiment of a method for organizing, processing, and accessing a database. As shown in FIGS. 1A-B, the method for organizing, processing, and accessing a database 100 may comprise the steps providing a database 105; and storing, on the database, a plurality of data from a plurality of previous projects 110.

In some embodiments, the previous projects may comprise a total previous project metric. In a preferred embodiment, the total previous project metric may be a value that is configured to convey to a user a cost of the previous project. In some embodiments cost may refer to capital, effort, time, materials, or any other quantification. In some embodiments, the cost may be unitless, and be used to convey a general sense of the previous project.

In some embodiments, the total previous project metric may comprise one or more task classes; wherein the task classes comprise one or more sub-task classes. In one embodiment, the total previous project metric may be a total time or cost, such that the previous total project metric may be one way to quantify a plurality of different task classes. For example, a single previous project may comprise a plurality of tasks. Each of the different tasks may be different measurements, such as length, time, number of units, or currency amount. In other amounts, each of the tasks may group together sub-tasks that are either of the same type of measurement, or a conversion to the same type of measurement. In some embodiments, the measurements may be a non-unit measurement.

In some embodiments, each of the one or more task classes may be configured to quantify tasks having similar units.

Another step may be determining a base reference value of the one or more task classes based on the total previous project metric 115. In some embodiments, the base reference value may be a starting point for spooling up a particular kind of task, which may then be modified by sub-tasks to generate additional data regarding estimates relating to the project. In some embodiments, a particular sub-task may provide data that either increases or decreases the overall cost of the task.

Another step may be determining a secondary reference value of the one or more sub-task classes based on the total previous project metric 120. In some embodiments, the sub-task classes may refer to specific components of completing a task. Preferably, the secondary reference value may be used to determine the cost of sub-tasks of present projects, such that the number of occurrences of a particular sub-task may be multiplied by the secondary reference value to determine a present value of that particular sub-task, which may then be added to present values of additional sub-tasks of a task, that when added to the base reference value, provide a value of that task.

Another step may be providing one or more present projects 125. The present projects may be stored within the database for additional processing.

The next step may be identifying one or more present tasks of the one or more present projects 130 and then identifying one or more present sub-tasks of the one or more present tasks 135.

Another step may be correlating the one or more present tasks with the one or more task classes and applying to the one or more present tasks the base reference value of the one or more task classes to generate a base present value 140. In some embodiments, this base present value may be indicative of the spooling up costs and/or effort of a task. In some embodiments, the base present value may be the same as the base reference value. In some embodiments, there may be a plurality of present tasks, each having their own corresponding base reference value.

Another step may be correlating the one or more present sub-tasks with the one or more sub-task classes and applying to the one or more present sub-tasks the secondary reference value of the one or more sub-task classes 145.

Another step may be multiplying the secondary reference value by a number of instances of the corresponding present sub-tasks to generate a secondary present value 150. In some embodiments, this secondary present value may be indicative of the costs and/or effort of completing a sub-task. In some embodiments, the secondary reference value may be the same as the secondary present value. In some embodiments, there may be a plurality of present sub-tasks, each with their own corresponding secondary reference value.

Another step may be adding the base present value and the secondary present value together to generate a weighted present value 155. In some embodiments comprising a plurality of tasks, each of the separate tasks may comprise its own weighted present value such that the sum of the weighted present values represents a present total project value.

In one embodiment, another may be converting the weighted present value into a currency or time 160. In this way, each of the weighted present values may be quickly assessed by a user.

Another step may be comparing the weighted present value to an actual value of the present project upon completion of the present project 170. In one embodiment, the actual value of the present project is determined after completion of the project. One benefit of this process would be to provide a recursive algorithm that allows the method to continually improve and become more accurate. As additional data is collected, the base reference values and/or the secondary reference values may be adjusted or revised. In some embodiments, as more data is collected, the method may include the creation of multiple tasks classes where previously only a single task class existed. In this way, the method may be able to fine tune its evaluation system by increasing the number of task classes.

In some embodiments, another step may be revising the base reference value and/or the secondary reference value to account for differences between the weighted present value and the actual value 175.

In some embodiments, the one or more task classes may comprise a total of n task classes, each having an nth weighted present value.

In alternate embodiments, a total present project value may be calculated by adding together a sum of the n task classes 180.

One benefit of a total present project value is that an entire project may be evaluated at a glance for any metric into which the total present project value may be translated, such as time and/or money. This may be beneficial for situations where accurate project estimations are beneficial.

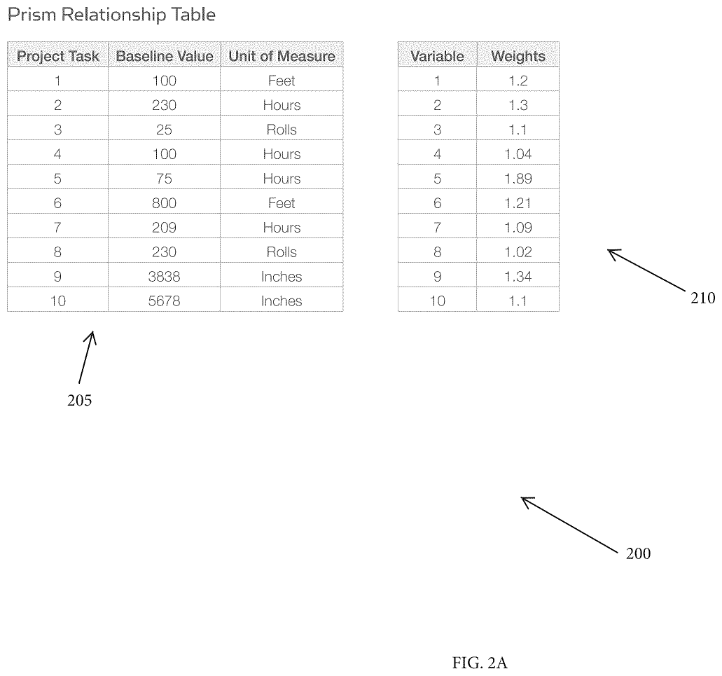

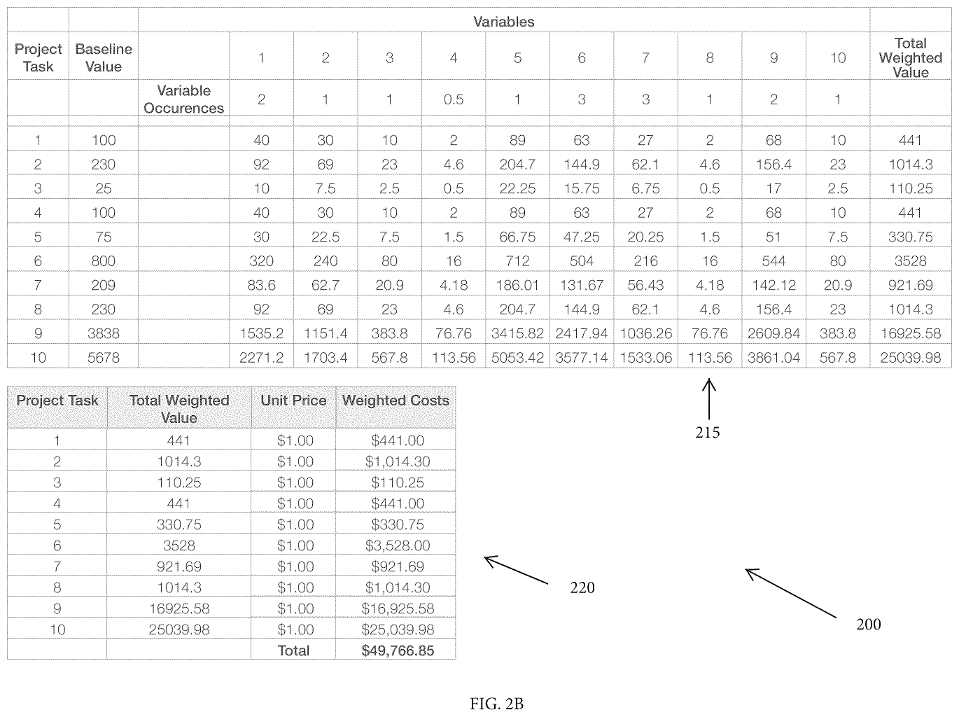

FIGS. 2A-B is set of tables that represent various values and calculations for a project. As shown in FIGS. 2A-B, the set of tables 200 may identify specific tasks of the project. Table 205 may comprise a project task, its current base value, and the unit of measure thereof. Table 210 may comprise variables or sub-tasks with their weights. For each project task, a baseline value may be applied and modified by sub-tasks, weight of specific sub-tasks, and occurrences of specific sub-tasks. In this embodiment, the term variable may be used similarly to sub-task as shown in table 215. In other embodiments, each of the tasks may comprise its own set of sub-tasks, related variables, weights, and variable occurrences.

As shown in FIGS. 2A-B, each of the project tasks may be assigned a total weighted value, and based on a ratio of price per weighted value, may translate each of the tasks into a total cost. In alternate embodiments, the total weighted value may be converted into a total time as shown in table 220.

The project depicted in FIGS. 2A-B comprises a total of 10 tasks, each of which comprises its own set of 10 variables or sub-tasks. In a preferred embodiment, the task and its sub-tasks are measured using the same kind of unit.

As shown in FIGS. 2A-B, while each of the tasks has a baseline value, the baseline values for each of the tasks may be different. In a preferred embodiment, the differences in the baseline value.

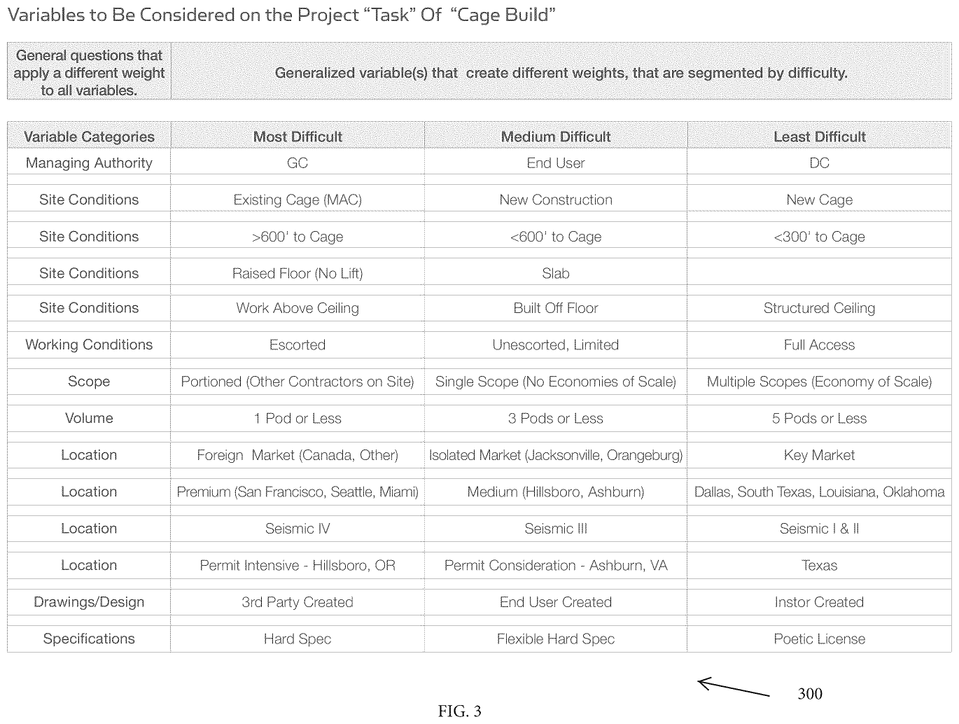

FIG. 3 is a table showing a set of variables considered for a particular task. As shown in FIG. 3, the overall project may include a task, wherein the task is cage build. The task may then comprise variables, or sub-tasks, including managing authority, four sets of site conditions, working conditions, scope, volume four sets of location, drawings/design, and specifications, as shown in table 300.

For example, the managing authority variable/sub-task may identify one or more high difficulty characteristics, one or more medium difficulty characteristics, and/or low difficulty characteristics. In some embodiments, the difficulty levels may be replaced with substantially any metric relevant to the variable/sub-task sorting. In other embodiments, characteristics may be identified individually instead of grouped into categories. Each of the individual characteristics or characteristic category may be assigned a particular value, which may be then multiplied by a number of occurrences of that characteristic, along with other variables/sub-tasks in order to generate a value for the task.

As shown, different tasks may have different types of metrics or units for evaluation. In some embodiments, numbers may be assigned to otherwise qualitative measurements.

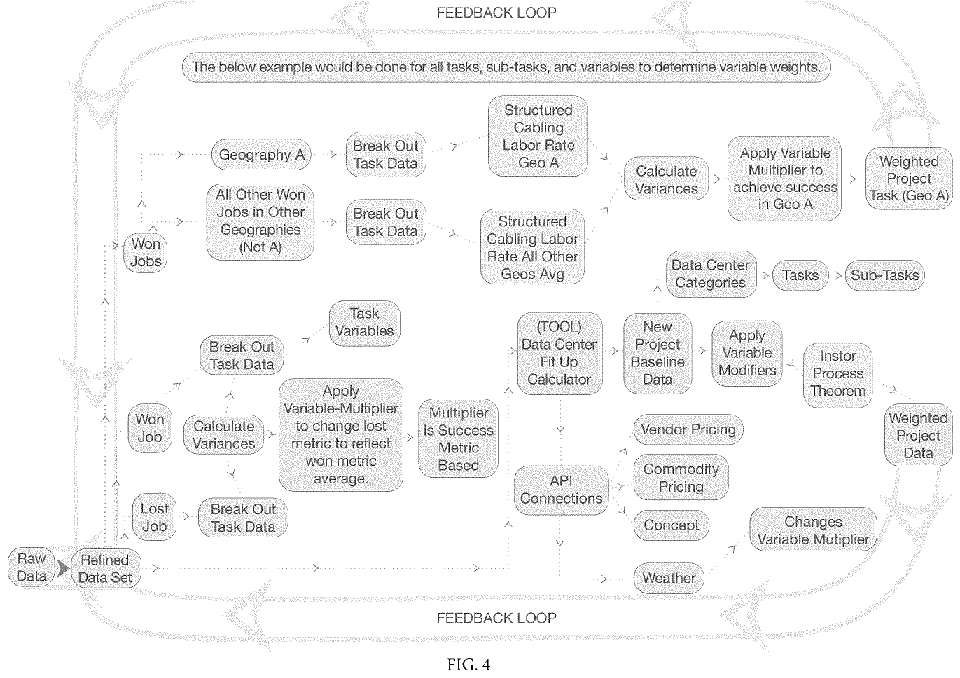

FIG. 4 is a flow diagram showing how various data may be processed and used for a project. As shown in FIG. 4, data may enter the system and be processed to generate a proposal for a job or project via the shown flow diagram 400. As shown in FIG. 4, the system may also be used to refine proposals for job or projects in order to increase the likelihood of success in being hired for the job. The flow diagram may also integrate third parties into the system by introducing information relating to the third parties, such as vendor pricing or commodity pricing.

As shown in FIG. 4, data for previous projects may be sequestered or analyzed based on geography.

In some embodiments, individuals may interact with the system in different ways depending on their roles with respect to projects. For example, some individuals may be able to manually change any of the data that may be used to generate reference values. In other embodiments, the reference values themselves for certain tasks and/or sub-tasks may be set directly by an individual. In some embodiments, the individual may be correcting an aberration to input data caused by unusual circumstances.

The disclosure presented herein above may be practiced by the use of computers, servers, databases, and other electronic devices.

In view of the exemplary systems described herein, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

Those of ordinary skill in the relevant art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for organizing, processing, and accessing a database, comprising the steps:
providing a database;
storing, on said database, a plurality of data from a plurality of previous projects;
wherein said plurality of previous projects comprise a total previous project metric;
wherein said total previous project metric comprises one or more task classes;
wherein said one or more task classes comprise one or more sub-task classes;
determining a base reference value of each of said one or more task classes based on said total previous project metric; and
determining a secondary reference value of each of said one or more sub-task classes based on said total previous project metric.

2. The method for organizing, processing, and accessing a database of claim 1, further comprising the steps:
providing one or more present projects;
identifying one or more present tasks of said one or more present projects; and
identifying one or more present sub-tasks of said one or more present tasks.

3. The method for organizing, processing, and accessing a database of claim 2, further comprising the step:
correlating said one or more present tasks with said one or more task classes and applying to said one or more present tasks said base reference value of said one or more task classes to generate a base present value.

4. The method for organizing, processing, and accessing a database of claim 3, further comprising the step:
correlating said one or more present sub-tasks with said one or more sub-task classes and applying to said one or more present sub-tasks said secondary reference value of said one or more sub-task classes.

5. The method for organizing, processing, and accessing a database of claim 4, further comprising the step:
multiplying said secondary reference value by a number of instances of said one or more present sub-tasks to generate a secondary present value.

6. The method for organizing, processing, and accessing a database of claim 5, further comprising the step:
adding said base present value and said secondary present value together to generate a weighted present value.

7. The method for organizing, processing, and accessing a database of claim 6, further comprising the step:
converting said weighted present value into a currency or time.

8. The method for organizing, processing, and accessing a database of claim 6, further comprising the step:
comparing said weighted present value to an actual value of a first of said one or more present projects upon completion of said first present project.

9. The method for organizing, processing, and accessing a database of claim 8, further comprising the step:
revising said base reference value or said secondary reference value to account for differences between said weighted present value and said actual value of said first present project.

10. The method for organizing, processing, and accessing a database of claim 9, wherein said one or more task classes comprise a total of n task classes, each having an nth weighted present value.

11. The method for organizing, processing, and accessing a database of claim 10, further comprising the step:
calculating a total present project value by adding together a sum of said n task classes.

12. A method for organizing, processing, and accessing a database, comprising the steps:
providing a database;
storing, on said database, a plurality of data from a plurality of previous projects;
wherein said previous projects comprise a total previous project metric;
wherein said total previous project metric comprises one or more task classes;
wherein said one or more task classes comprise one or more sub-task classes;
determining a base reference value of each of said one or more task classes based on said total previous project metric;
determining a secondary reference value of each of said one or more sub-task classes based on said total previous project metric;
providing one or more present projects;
identifying one or more present tasks of said one or more present projects;
identifying one or more present sub-tasks of said one or more present tasks;
correlating said one or more present tasks with said one or more task classes and applying to said one or more present tasks said base reference value of said one or more task classes to generate a base present value;
correlating said one or more present sub-tasks with said one or more sub-task classes and applying to said one or more present sub-tasks said secondary reference value of said one or more sub-task classes;
multiplying said secondary reference value by a number of instances of said one or more present sub-tasks to generate a secondary present value;
adding said base present value and said secondary present value together to generate a weighted present value;
converting said weighted present value into a currency or time;
comparing said weighted present value to an actual value of a first of said one or more present projects upon completion of said first present project;
revising said base reference value or said secondary reference value to account for differences between said weighted present value and said actual value of said first present project;
wherein said one or more task classes comprise a total of n task classes, each having an nth weighted present value; and
calculating a total present project value by adding together a sum of said n task classes.
